(19) United States
(12) Patent Application Publication
(10) Pub. No.: US 2008/0246743 A1
(43) Pub. Date: Oct. 9, 2008

(54) Transport Control Module for Remote Use

(75) Inventor: Matthew F. Ward, Philadelphia, PA (US)

Correspondence Address: Element Labs, Inc., 3350 Scott Blvd., Bldg 2, Santa Clara, CA, 95054, US

(73) Assignee: Element Labs, Inc., Santa Clara, CA (US)

(21) Appl. No.: 12/062,680

(22) Filed: Apr. 4, 2008

Related U.S. Application Data
(60) Provisional application No. 60/910,512, filed on Apr. 6, 2007.
(60) Provisional application No. 60/910,516, filed on Apr. 6, 2007.

(51) Int. Cl. G06F 3/041

(52) U.S. Cl. 345/173

(57) ABSTRACT

A method of controlling a light emitting display includes receiving an input signal with a transport control module that includes a touch screen, displaying a command overlay that includes an input command on the touch screen, selecting the input command from the command overly, processing the input signal based upon the selected input command, thereby producing an output signal, and outputting the output signal to the light emitting display.

### CROSS-REFERENCE TO RELATED APPLICATIONS

This application, pursuant to 35 U.S.C. § 119(e), claims priority to U.S. Patent Application Ser. No. 60/910,512 filed on Apr. 6, 2007 and entitled “Transport Control Module for Remote Use” in the name of Matthew Ward, which is hereby incorporated by reference in its entirety. Further, still pursuant to 35 U.S.C. § 119(e), this application also claims priority to U.S. Patent Application Ser. No. 60/910,516 filed on Apr. 6, 2007 and entitled “A System for Creating Content for Video Based Illumination Systems” in the names of Jeremy Hochman, Christopher Varrin, and Matthew Ward, which is hereby incorporated by reference in its entirety.

### BACKGROUND

1. Field of the Disclosure

Embodiments disclosed herein generally relate to apparatuses for controlling light emitting displays. More specifically, embodiments disclosed herein relate to an improved method and apparatus for an interface for controlling the output of a light emitting display.

2. Background Art

Display units for entertainment, architectural, and advertising purposes have commonly been constructed from numbers of light emitting elements, such as light emitting diodes (“LEDs”) or incandescent lamps mounted onto flat panels. The light emitting elements may be selectively turned on and off to create patterns, graphics, and video displays for both informational and aesthetic purposes. It is well known to construct these displays as tiles or large panels which are assembled in position for a specific entertainment show or event, or also as an architectural or advertising display. Examples of such systems are disclosed in U.S. Pat. Nos. 6,813,853, 6,704,989 and 6,314,669.

The use of remote interfaces to control video playback and record functions is very common. These vary from the wireless remote control in a home to the sophisticated tape transport functions that are incorporated into some video switchers. In a professional environment, the common uses include editing, live production, and presentation. As video technology creeps into more aspects of our lives, it also extends more deeply into all aspects of professional applications. One area that is seeing the increase use of video is the field of lighting, where the line between a video source and a lighting source has become blurred.

Traditional tape transport controllers are typically straight-forward. There is usually a multi-function knob which switches between jog and shuttle. This allows an operator to move quickly while making fine adjustments required for cueing and editing. Examples of such devices are the classic Sony RM series edit controllers and the Buf Box controllers used in many broadcast trucks. These controllers feature one or two jog/shuttle knobs and a series of buttons which perform certain tasks.

Further, all of these controllers emulate the functions of the typical front panel of a Video Tape Recorder (VTR). In many functions, however, the VTR has been replaced by a Hard Disk Recorder (HDR) of some kind. And, more often, now the video source is a generic computer or a highly customized Video Server. It is the last two options listed where industries outside of the mainstream video industry have adopted video playback.

FIG. 1 shows a controller that represents the most basic form of control in the professional market. A simple Jog/Shuttle knob 100 is on a remote cable 102 with several buttons 104 representing the basic functions of Stop, Record, Play, Rewind, Fast Forward, Pause. There is an additional button 106 for the Jog/Shuttle setting. This controller duplicates the functions of the front panel of a basic VTR meaning that the deck does not need to be directly in front of the operator.

FIG. 2 shows the Classic Sony RM-450 Edit Controller that has been used for basic two deck editing for many years. There are two Jog/Shuttle knobs 200, each of which is dedicated to a specific deck. Once again, there are usually remote cables (not shown) and a series of buttons 202 which correspond to various front panel functions on the VTRs. One addition on this larger controller is the pair of displays 210 that may be used to view the time code on the VTRs.

FIG. 3 shows an example of a Panasonic edit controller. The AG-571 Edit Controller is a simple two deck controller with minimal control and display functionality.

FIG. 4 shows a Buf Controller that is very popular on broadcast trucks and in other live events. The controller features the traditional Jog/Shuttle knob 400 and a cluster of transport control buttons 405 with Record 406, Stop 407, and Play 408 buttons located just below the Jug/Shuttle knob 400. The controller may display the status of the VTRs in a pair of small LCD screens 410. There is a row of ten buttons 415 allowing the operator to select one or more VTRs. By double clicking on these buttons, an operator may group VTRs together for certain cues. The navigation is filled out by a full 10 key numerical pad 420 and a set of four keys 421 for up, down, left, and right.

FIG. 5 shows an off axis view of the Buf Controller, and is intended to show issues inherent with the layout of control panels which are solely dependent on buttons. The Up/Down/Left/Right buttons 500 are very close to the numerical pad and the other transport control keys. In addition the Jog/Shuttle knob 501 sits in front of some of the VTR selection keys.

Current control requirements for large shows and productions have created the need for a controller that extends beyond controllers in prior art. Accordingly, there exists a need for a controller that allows connectivity to modern video playback sources and integrates the functions in a way that allows the possibility for the controller to be integrated into a larger show control system.

### SUMMARY OF THE DISCLOSURE

In one aspect, embodiments herein relate to a method of controlling a light emitting display includes receiving an input signal with a transport control module that includes a touch screen, displaying a command overlay that includes an input command on the touch screen, selecting the input command from the command overly, processing the input signal based upon the selected input command, thereby producing an output signal, and outputting the output signal to the light emitting display.

In another aspect, embodiments disclosed herein relate to an apparatus for controlling a light emitting display that includes a transport control module configured to receive an input signal. The transport control module includes a touch screen configured to display a command overlay comprising an input command and at least a portion of the input signal and a knob configured to receive a jog command or a shuttle command.

In yet another aspect, embodiments disclosed herein relate to a method of remotely controlling a light emitting display including receiving an input signal with a transport control module comprising a touch screen, displaying a command overlay comprising an input command on the touch screen, selecting the input command from the command overlay, processing the input signal according to the selected input command, thereby producing an output signal, electrically connecting the transport control module to the light emitting display over a communications network, and outputting the output signal to the light emitting display through the communications network.

Further, in yet another aspect, embodiments disclosed herein relate to a system for remotely controlling a light emitting display including a transport control module configured to receive an input signal. The transport control module includes a touch screen configured to display a command overlay comprising an input command, receive a touch input, and display at least a portion of the input signal and a knob configured to receive a jog command or a shuttle command. The transport control module is electrically connected with the light emitting display.

### BRIEF DESCRIPTION OF DRAWINGS

FIG. 1 shows a perspective view of a prior art transport controller.

FIG. 2 shows a perspective view of a prior art transport controller.

FIG. 3 shows a perspective view of a prior art transport controller.

FIG. 4 shows a perspective view of a prior art transport controller.

FIG. 5 shows a perspective view of a prior art transport controller.

FIG. 6 shows a block diagram of a system in accordance with embodiments disclosed herein.

FIG. 7 shows a perspective view of a transport control module in accordance with embodiments disclosed herein.

FIG. 8 shows a side perspective view of a transport control module in accordance with embodiments disclosed herein.

FIG. 9 shows a perspective view of a transport control module in accordance with embodiments disclosed herein.

FIG. 10 shows a perspective view of a transport control module in accordance with embodiments disclosed herein.

FIG. 11 shows a front view of a transport control module in accordance with embodiments disclosed herein.

FIG. 12 shows a perspective view of a master control system in accordance with embodiments disclosed herein.

FIG. 13 shows a perspective view of a master control system in accordance with embodiments disclosed herein.

FIG. 14 shows a view of a master control system in accordance with embodiments disclosed herein.

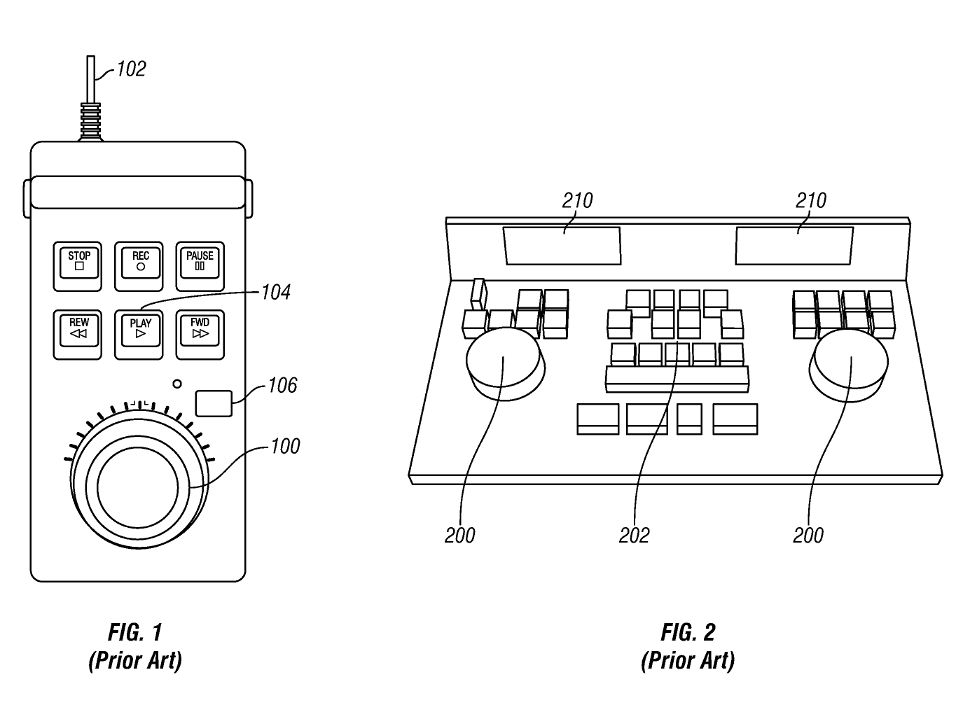

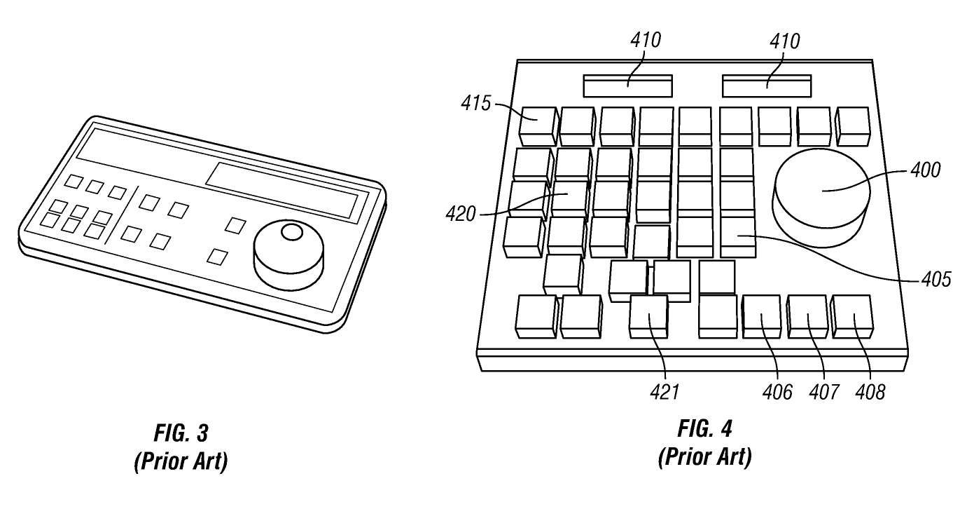

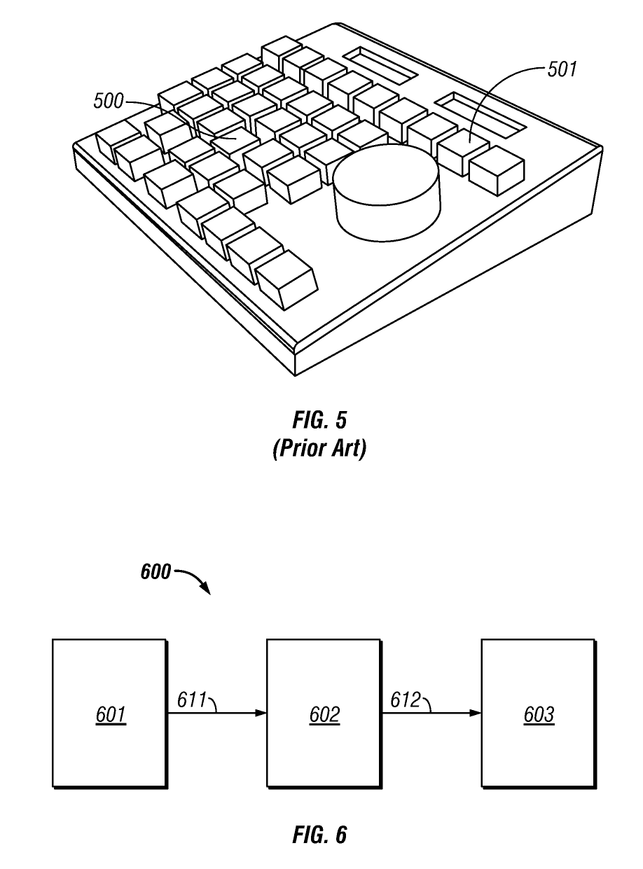

### DETAILED DESCRIPTION

Specific embodiments of the present disclosure will now be described in detail with reference to the accompanying figures. Like elements in the various figures may be denoted by like reference numerals for consistency. Further, in the following detailed description of embodiments of the present disclosure, numerous specific details are set forth in order to provide a more thorough understanding of the invention. However, it will be apparent to one of ordinary skill in the art that the embodiments disclosed herein may be practiced without these specific details. In other instances, well-known features have not been described in detail to avoid unnecessarily complicating the description.

In one aspect, embodiments disclosed herein generally relate to an apparatus and method for controlling video playback on a light emitting display. The apparatus may include a transport control module that includes a touch screen and a knob. The touch screen may be configured to display a command overlay including an input command, and the input command may be selected by touching the touch screen. The transport control module may receive an input signal from, for example, a video source and process the input signal based upon the input command selected on the touch screen, thereby resulting in an output signal. The transport control module may then output the resulting output signal to, for example, a light emitting display.

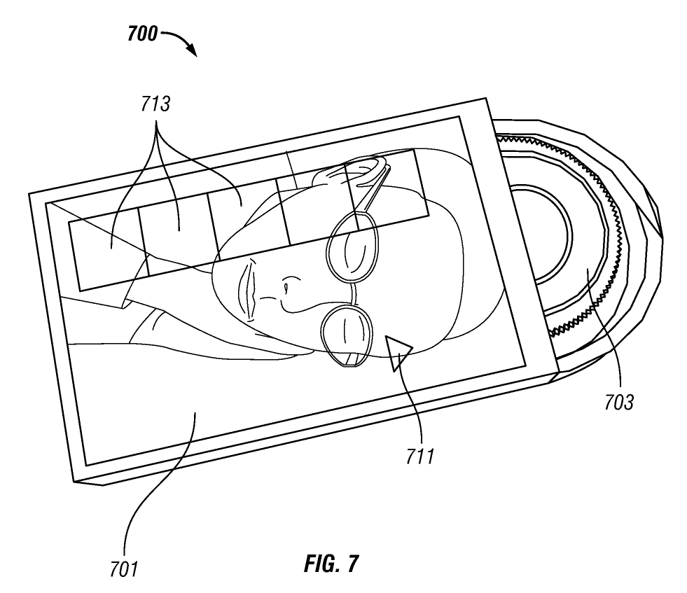

Referring now to FIG. 6, a block diagram of a system 600 in accordance with embodiments disclosed herein is shown. A video source 601 is electrically connected through a first connection 611 to a transport control module 602. The video source 601 may supply an input signal to the transport control module 602. Examples of possible video sources include, but are not limited to: video cameras, digital cameras, digital tapes, hard disk drives, and optical storage media, such as digital video discs, compact discs, and Blu-ray discs. First connection 611 may be a direct electrical connection over a cable. Example cables may include, for example, a high definition multimedia interface (“HDMI”) cable, a digital visual interface (“DVI”) cable, a universal serial bus (“USB”) cable, and a FireWire cable. Alternatively, first connection 611 may be an indirect connection that connects video source 601 to transport control module 602 over a communications network. Example communications networks may include, for example, a local area network, a wide area network, a wireless network, and the internet.

The transport control module 602 may receive the input signal from video source 601, and process the input signal based on input commands received through a touch screen interface, thereby resulting in an output signal. For example, if the input signal is a video file being played back from a hard disk drive, the transport control module may receive an input command to pause the video. Alternative processing techniques utilized by the transport control module may include, for example, fast-forwarding, rewinding, displaying a status indicator such as time remaining, time elapsed, track size, or clip size, jumping to a specific time, scene, or track in the video, and adjusting control cues. The resulting output signal may then be transmitted from transport control module 602 to light emitting display 603 over a second connection 612. Second connection 612 may include any of the direct or indirect electrical connections discussed above with respect to first connection 611.

Finally, the processed output signal may be displayed on light emitting display 603. Light emitting display 603 may include any display well known in the art including, for example: light emitting diode (“LED”) tile displays, liquid crystal displays (“LCDs”), televisions, and plasma televisions.

Referring now to FIG. 7, a transport control module 700 in accordance with embodiments disclosed herein is shown. The transport control module 700 includes a touch screen 701, a knob 703, a status indicator 711, and command overlays 713. Touch screen 701 may employ any touch screen sensor technology well known in the art, such as resistive sensors, capacitive sensors, surface acoustic wave sensors, and optical imaging sensors. Touch screen 701 allows the transport control module 700 to simultaneously display information to a user and accept input from command overlays 713. Each command overlay 713 may include one or more input commands. The input commands may allow a user to select among various ways of processing an input signal transmitted to transport control module 700, as discussed above with respect to FIG. 6. A user may select among the input commands by simply touching the desired input command on touch screen 701. Examples of input commands include all of the processing techniques discussed above with respect to FIG. 6.

Each command overlay 713 may display information in addition to input commands. For example, a command overlay may display a preview of the result of processing an input signal according to an input command corresponding to the command overlay. Alternatively, a command overlay may simply display information concerning an input video signal such as, for example, track number, track size, clip number, clip size, control cues, elapsed time, time remaining. Alternatively the input signal may only include the information concerning a video and not include an actual video signal. Various command overlays 713 may be brought up as required by a user. For example, a basic configuration of touch screen 701 may have a preview content command overlay that displays the video in the background of touch screen 701 and a status indicator command overlay that displays status indicator 711. While status indicator 711 is shown to indicate that a video is playing, other indicators may include fast-forward, rewind, pause, and other well known controls.

Command overlays 713 may also receive input commands directly from knob 703. Generally, knob 703 is used as a jog or shuttle knob as is well known in the art. Jog refers to advancing or backing through a video or audio track at a slower speed, whereas shuttle refers to advancing or backing at a faster speed.

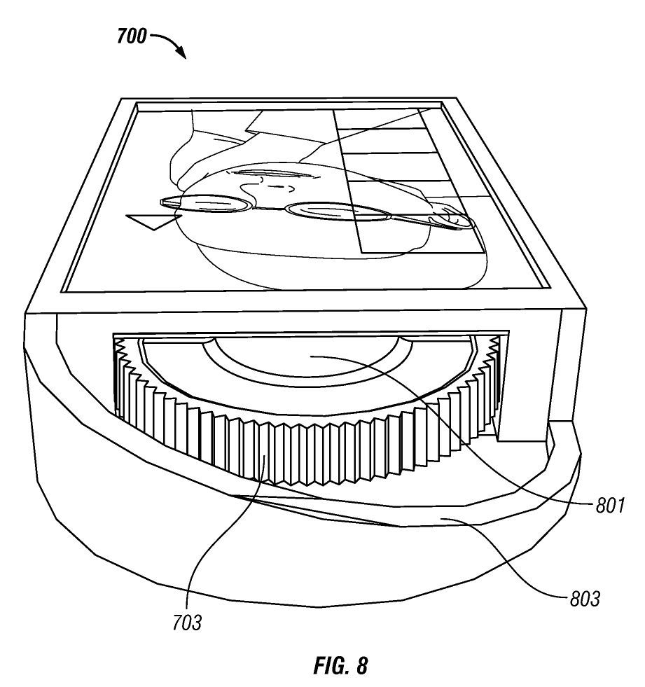

Referring now to FIG. 8, an alternative perspective view of transport control module 700 is shown. Knob 703 includes a toggle input 801 that allows knob 703 to toggle between input modes. For example, pressing toggle input 801 may alternate knob 703 between jog and shuttle input modes. Furthermore, transport control module 700 may include a cutout 803 in order to make the module more comfortable or ergonomic for a user holding the module.

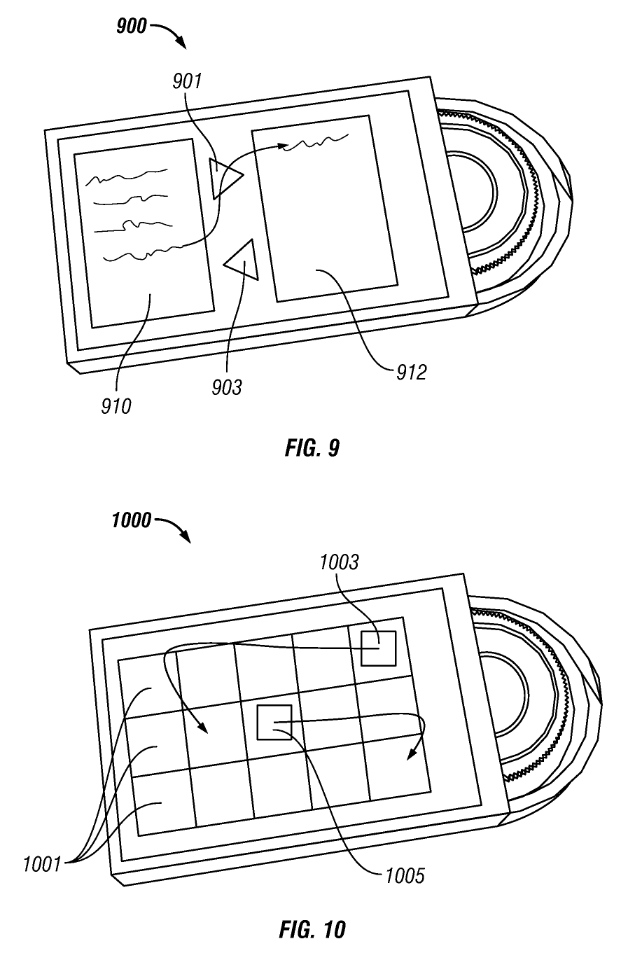

Referring now to FIG. 9, a transport control module 900 including a touch screen according to embodiments disclosed herein is shown. Transport control module 900 includes a queue list command overlay that includes buttons 901, 903 and queue lists 910, 912. In the queue list command overlay, available clips may be displayed on first queue list 910, and a current play list may be displayed on second queue list 912. Clips may be added to the play list by selecting a clip from first queue list 910 and touching button 901 on the touch screen. Clips may be removed from the play list by selecting a clip from second queue list 912 and touching button 903 on the touch screen. In this embodiment, an output signal from transport control module 900 may be a video signal derived from playing the clips from second queue list 912 in the order displayed. The current output signal to the light emitting display may be displayed behind the queue list command overlay on the touch screen. Alternatively, an input signal to transport control module 900 may be displayed behind the queue list command overlay on the touch screen. The queue list command overlay may cover all or part of the input signal or output signal displayed in the background.

Referring now to FIG. 10, a transport control module 1000 according to embodiments disclosed herein is shown. Transport control module 1000 includes a file management command overlay 1001 that includes video clips 1003, 1005. File management command overlay 1001 includes compartments that may represent, for example, folders on a file system, television shows, movie scenes, lighting environments, or macros. Input commands to file management command overlay 1001 include dragging and dropping touch gestures. For example, a user may touch first clip 1003 and drag it to a different compartment. Transport control module 1000 may change the processing of clips 1003, 1005 depending on their placement in the compartments of file management command overlay 1001. A user may also touch a compartment displayed within file management command overlay 1001 in order to see what clips are available in the compartment.

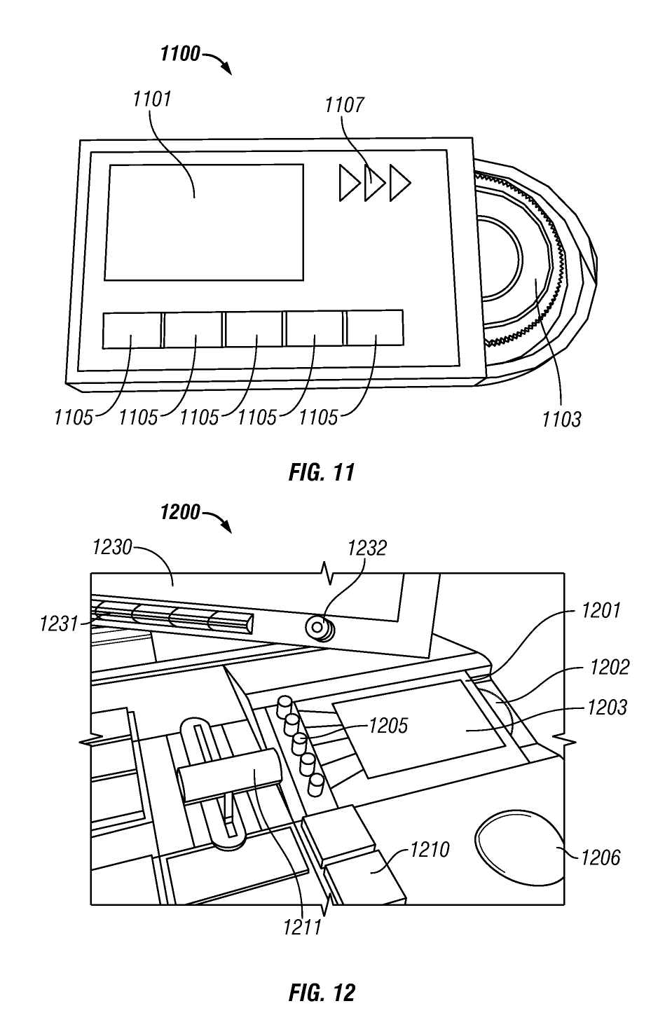

Referring now to FIG. 11, a transport control module 1100 according to embodiments disclosed herein is shown. Transport control module 1100 includes a knob 1103 and a search command overlay including a clip 1101, key frames 1105, and a status indicator 1107. Knob 1103 may allow jog or shuttle functionality as described above in order to search through clip 1101. As clip 1101 is advanced or backed up by knob 1103, key frames 1105 may be taken by touching the search command overlay. Each time key frame 1105 is taken, a shortcut is created to a certain time in clip 1101. Key frames 1105 may be touched to jump to the times associated with key frames 1105. Alternatively, knob 1103 may also be used to scroll through the key frames 1105. Status indicator 1107 indicates how fast clip 1101 is advancing or backing up during a search.

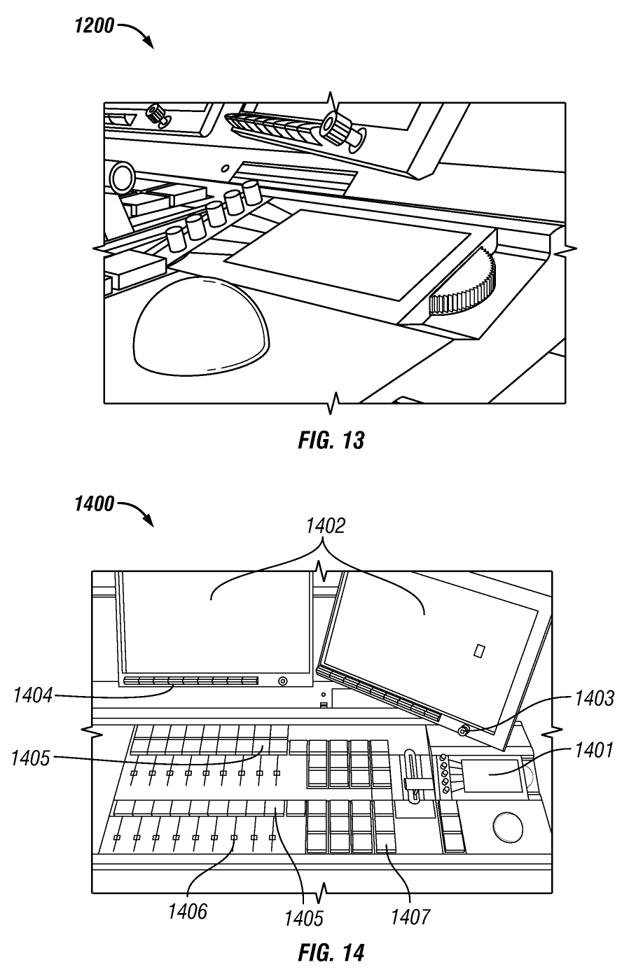

Referring now to FIG. 12, a master control system 1200 including a transport control module 1201 according to embodiments disclosed herein is shown. Transport control module 1201 includes a knob 1202 and a touch screen 1203. Master control system 1200 allows for the integration of transport control module 1201 and queuing functions into a show control system that allows for switching and routing. To better handle the additional complexity, additional control knobs 1205 may be added to control touch screen 1203. A track ball 1206 may also be included for additional control. User programmable physical buttons 1210 may be included with functions that may be assigned using touch screen 1203. A T-bar 1211 may also be included for additional control. Because both transport control and switching often deal with multiple recorded sources it is useful to integrate them into a single system. FIG. 13 shows an additional perspective view of master control system 1200.

Referring now to FIG. 14, a master controller 1400 including a transport control module 1401 according to embodiments disclosed herein is shown. Master controller 1400 includes multiple large monitors 1402, which may be touch screen monitors. Monitors 1402 include a set of buttons 1404 which may enable a user to shift monitor 1402 between multiple configurations. A monitor knob 1403 may allow navigation that is not efficiently handled on the touch screen included in transport control module 1401. Monitor knob 1403 may also function as a two-dimensional pointing device.

Master controller also includes input selection buses 1405. The individual buttons corresponding to input selection buses 1405 may include small indicators or display units allowing the buttons to show current status or to communicate the current function assigned to the button. Master controller further includes a fader 1406. Fader 1406 may enable a user to be able to hold down a button to move into an editing function and then use fader 1406 to scan through a list of functions. Functions include the selection of an input over a network or the assignment of a specific internal effect to a button. Master controller also includes a macro button 1407, which may be controlled in software and programmed through the touch screen included in transport control module 1401.

Embodiments disclosed herein may provide for one or more of the following advantages. First, the present disclosure may provide for remote control of light emitting displays through a transport control module. Because the transport control module may be connected to both a video source and a light emitting display through, for example, the internet, a user may control the output from the light emitting display from any remote location with internet access. Next, the present disclosure may provide for a transport control module that offers increased portability and modularity, because it may be used as a single unit or integrated into a larger master control unit with additional functionality. Finally, the present disclosure may provide for increased efficiency in video editing by allowing a user to simultaneously utilize the full features of a master controller with the drag and drop functionality of a touch screen included in a transport control module.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A method of controlling a light emitting display, the method comprising:
receiving an input signal with a transport control module comprising a touch screen;
displaying a command overlay comprising an input command on the touch screen;
selecting the input command from the command overlay;
processing the input signal based upon the selected input command, thereby producing an output signal; and
outputting the output signal to the light emitting display.

2. The method according to claim 1, wherein the command overlay comprises at least one of a preview content command overlay, a status indicator command overlay, a queue list command overlay, and a file management command overlay.

3. The method according to claim 1, wherein the input command comprises one of a play command, a pause command, a fast-forward command, and a rewind command.

4. The method according to claim 1, wherein the command overlay comprises a plurality of command overlays, each of the command overlays comprising an input command.

5. The method according to claim 1, wherein the command overlay comprises a plurality of input commands.

6. The method according to claim 1, further comprising:
displaying at least a portion of the input signal on the touch screen.

7. The method according to claim 1, further comprising:
electrically connecting the transport control module to the light emitting display through a communications network.

8. The method according to claim 7, wherein the communications network comprises at least one of a local area network, a wireless network, and the internet.

9. The method according to claim 1, further comprising:
electrically connecting the transport control module to a video source; and
transmitting the input signal from the video source to the transport control module.

10. The method according to claim 9, wherein the transport module is electrically connected to the video source through at least one of: a high definition multimedia interface (“HDMI”) cable, a digital visual interface (“DVI”) cable, a universal serial bus (“USB”) cable, and a FireWire cable.

11. The method according to claim 9, wherein the transport module is electrically connected to the video source through a communications network.

12. The method according to claim 11, wherein the communications network comprises at least one of a local area network, a wireless network, and the internet.

13. The method according to claim 9, wherein the video source comprises at least one of: an optical storage medium, a disk drive, a digital tape, a digital camera, and a video camera.

14. An apparatus for controlling a light emitting display, the apparatus comprising:
a transport control module configured to receive an input signal, comprising:
a touch screen configured to display a command overlay comprising an input command and at least a portion of the input signal; and
a knob configured to receive a jog command or a shuttle command.

15. The apparatus of claim 14, wherein the transport control module is configured for remote use with a light emitting display.

16. The apparatus of claim 14, wherein the transport control module is adapted to connect to a master control system.

17. The apparatus of claim 14, wherein the knob further comprises a toggle input for toggling between a jog command mode and a shuttle command mode.

18. A method of remotely controlling a light emitting display, the method comprising:
receiving an input signal with a transport control module comprising a touch screen;
displaying a command overlay comprising an input command on the touch screen;
selecting the input command from the command overlay;
processing the input signal according to the selected input command, thereby producing an output signal;
electrically connecting the transport control module to the light emitting display over a communications network; and
outputting the output signal to the light emitting display through the communications network.

19. The method according to claim 18, further comprising:
electrically connecting the transport control module to a video source; and
transmitting the input signal from the video source to the transport control module.

20. The method according to claim 18, wherein the communications network comprises at least one of a local area network, a wireless network, and the internet.

21. A system for remotely controlling a light emitting display, the system comprising:
a transport control module configured to receive an input signal, comprising:
a touch screen configured to display a command overlay comprising an input command, receive a touch input, and display at least a portion of the input signal; and
a knob configured to receive a jog command or a shuttle command;
wherein the transport control module is electrically connected with the light emitting display.

22. The system according to claim 21, wherein the transport control module is electrically connected with the light emitting display through a communications network.

23. The system according to claim 22, wherein the communications network comprises at least one of a local area network, a wireless network, and the internet.

24. The system according to claim 21, further comprising a video source electrically connected to the transport control module, wherein the video source is configured to transmit the input signal to the transport control module.
